(19) United States
(12) Patent Application Publication
(10) Pub. No.: US 2007/0165206 A1
(43) Pub. Date: Jul. 19, 2007

(54) Installation for processing plate-shaped substrates

(76) Inventors: Arnold Olesch, Altenstadt (DE); Manfred Weimann, Alzenau (DE); Dirk Remmlinger, Kleinostheim (DE); Alfred Rick, Karlstein (DE); Holger Ratschat, Gelnhausen (DE); Frank Mertens, Bad Nauheim (DE); Andreas Sauer, Grossostheim (DE); Harald Wurster, Mombris (DE)

Correspondence Address: FULBRIGHT & JAWORSKI, LLP, 666 FIFTH AVE, NEW YORK, NY, 10103-3198, US

(21) Appl. No.: 10/586,513

(22) PCT Filed: Apr. 10, 2004
(86) PCT No.: PCT/EP04/03842

§ 371 Date: Jul. 18, 2006

(51) Int. Cl. G01P 3/36

(52) U.S. Cl. 356/28

(57) ABSTRACT

In order that an installation for coating panes of glass can be operated more reliably, the invention proposes a modification of the light barriers used in the installation. On the receiver side of these light barriers there is a row of individual cells which are more or less shaded according to the thickness of the glass pane passing through the ray path of the light barrier. Some cells always deliver a significantly reduced signal which can be evaluated as a reliable indication of the presence of an object in the ray path.

The invention relates to an installation for processing plate-shaped substrates, especially for coating panes of glass, comprising a transport path on which the substrates to be processed are successively fed to a processing station, and comprising a light barrier over the transport path in order to be able to control the flow of the substrates, wherein the light barrier consists of an emitter which emits a light beam over the transport path to a receiver connected to an electronic evaluation device, which is installed such that, as a result of the shading of the receiver by the substrates guided over the transport path, it generates a switching signal which indicates the presence of a substrate in the light beam.

Installations for coating glass are constructed such that panes of glass of different dimensions, especially of different thickness, can be continuously processed. For this purpose the installations consist of individual processing stations for the pre-treatment, coating and after-treatment of panes of glass. Between and in the stations, the panes of glass are moved on roller conveyors wherein at least some of the rollers of the roller conveyors are driven by electric motors to transport the panes of glass.

In order to ensure a smooth sequence, a certain amount of information is required on the positions of the panes of glass on the roller conveyors. It is furthermore helpful if the control system of the installation contains information, especially on the thickness of the panes. For example, it may be necessary to set locks at the inlet and outlet of the processing stations to the respective thickness of the panes of glass in order to keep pressure losses as low as possible.

For this purpose, at various positions on the transport path there are light barriers which at least provide the information as to whether a pane of glass is located at the respective position. Furthermore, information on the thickness of the glass pane located in the light barrier can be deduced from the signal intensity of the receiver.

The light barriers used so far consist of an emitter and a receiver, wherein the emitter has a point-shaped light source, the light of which is formed by means of a lens into a parallel light beam, the diameter of which is significantly larger than the thickness of the panes of glass processed in the installation.

On the receiver side, the light beam is focused onto a central light-sensitive cell by another lens.

If there is no break in the light beam, the total intensity of the light beam is fed into the light-sensitive cell. As soon as the light beam is partly shaded, the total measured intensity is reduced. If this falls below a certain threshold value, this can be taken as an indication that there is an obstacle, i.e. a pane of glass, in the light beam. The extent of the reduction in the measured intensity also gives an indication of the thickness of the pane of glass.

This type of light barrier has the following disadvantage: In order that relatively thin panes can be reliably identified, the threshold value has to be just below the total intensity. However, since this can fluctuate as a result of other influences, e.g., the intensity of the light emitted by the emitter can vary, this can result in misinterpretations of the measured signal. If the threshold value is set too low to avoid such misinterpretations—the difference to the full intensity is thus too large—thin panes of glass, on the other hand, cannot be reliably identified.

Finally, the thickness measurement is too inaccurate since it cannot be ensured that the light beam is aligned parallel to the pane of glass. The shading cross-section is thereby larger so that it would appear that a thicker plate is running through the ray path than is actually the case.

The invention is thus based on the problem of producing an installation for processing plate-shaped substrates, especially for coating panes of glass, and providing the installation with sensors such that the installation control system obtains reliable information on the position of the substrates in the installation and if necessary, also information on their thickness.

In order to solve this problem, an installation is proposed according to the preamble of claim 1, wherein the receiver of the light barrier has a plurality of light-sensitive cells arranged one above the other, wherein the evaluation circuit is set up such that a switching signal is given when more than a certain minimum number of cells is shaded.

Such a light barrier makes it possible to achieve significantly more reliable determinations of position. Also, since at least several light cells are completely shaded even with very thin plates, reliable detection is always possible. Since the individual cells are always completely shaded, it can also be clearly distinguished for each cell whether said cell receives light from the emitter or lies in the shade of a glass plate travelling through the light beam. Misinterpretations are thereby impossible. The point of the invention is thus to use not only one central light-sensitive cell onto which the light beam is focused and which thus records the total intensity of the light beam when the light barrier is undisturbed, but to use a plurality of individual cells located one above the other which are quasi-assigned to the individual rays of the light beam. In this way, the shading of individual cells can be detected substantially more easily.

Any misinterpretations can be reduced still further if the signal is not evaluated from all the cells but only from those cells lying in a smaller detection region, which is only slightly larger than the substrate with the smallest thickness so that, at least in the case of thicker substrates, all the cells lying in the detection region are shaded and no longer deliver a signal. In this case, the assignment of the cells to the detection region need only take place after the light barrier installation has been installed so that during a test run of the installation it can be determined which cells lie in the shaded region.

When the minimum number of cells, the shading of which triggers a switching signal, is determined such that the vertical region covered thereby is smaller than the smallest substrate height to be processed by the installation, even the flattest substrate to be processed in the installation can be reliably detected.

In order that a thickness measurement can be made, the signals of all the cells must be taken into account which naturally assumes that the total height of the cells lying one above the other is greater than the largest thickness of substrates. For a light beam running parallel to the substrates, the number of shaded cells corresponds to the height of the passing substrate. This information is transported by the switching signal which contains the number of shaded cells.

In this case, however, there is also a need to take into account measurement errors as a result of misadjustments which arise because the light beam does not run absolutely parallel to the substrate, or the emitter or the receiver are positioned obliquely. This would have the result that, depending on the direction of the misadjustment, more or less cells are affected than need actually be the case. However, since the required measurement accuracy is smaller than the sensitive area of the individual cells, the errors associated with any misadjustment can be accepted.

The invention will be explained in detail below with reference to an exemplary embodiment. In the figures:

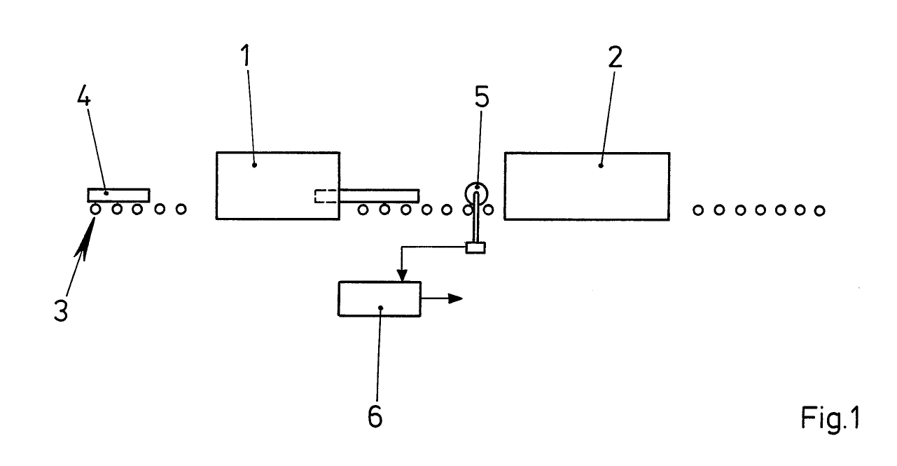

FIG. 1 shows the schematic structure of an installation for processing plate-shaped substrates,

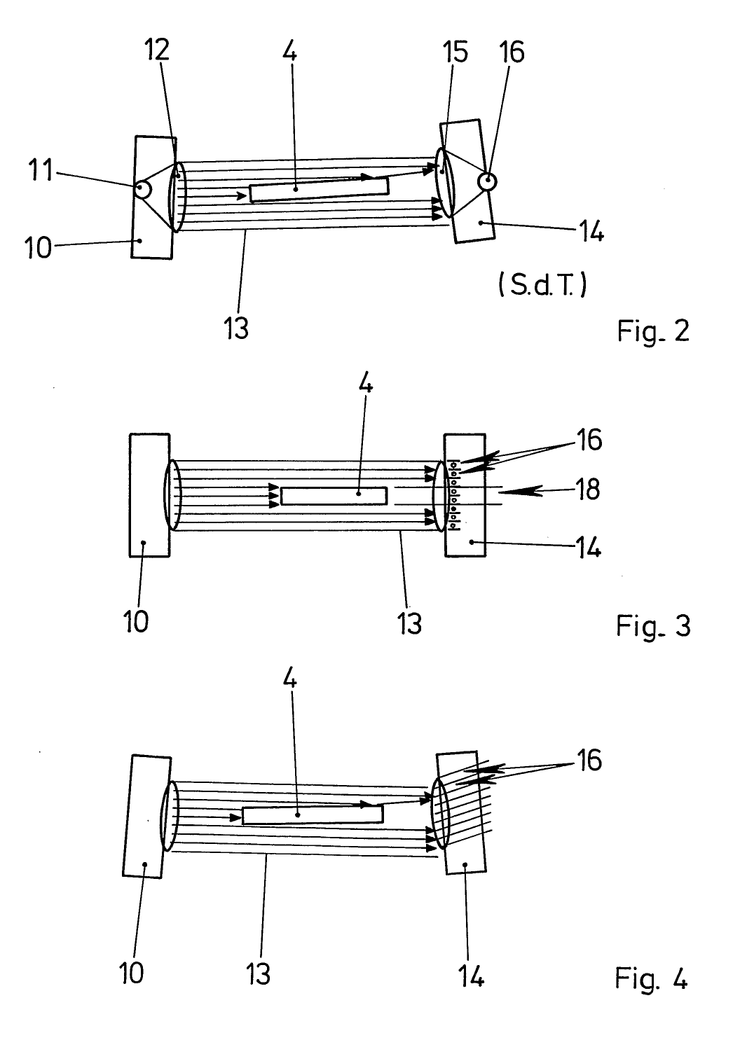

FIG. 2 shows a light barrier arrangement according to the prior art with misalignment,

FIG. 3 shows a light barrier according to the invention,

FIG. 4 shows a light barrier according to FIG. 3 with a misadjustment.

A coating installation for plate-shaped substrates, especially for coating panes of glass, is shown schematically in FIG. 1. This installation consists of a plurality of stations 1, 2 which are interconnected via transport paths represented by so-called roller conveyors 3. The substrates, in this case panes of glass 4, move on these roller conveyors through the stations 1, 2 and between said stations.

The installations are designed such that panes of glass 4 having different dimensions and thicknesses can be processed or coated, wherein for optimum usage of the installation successive differing plates are also to be processed.

For a smooth sequence, it is important to identify the positions of the panes of glass 4. For this purpose, light barriers 5 are provided, one of which is shown schematically in FIG. 1.

These light barriers are connected to an evaluation unit 6 which is part of the control system of the installation. The light barriers determine the positions 1, 2 of the panes of glass 4 during passage through the installation so that by suitably controlling drives, locks and the like, collisions of the panes of glass with one another or with locks not opened wide enough can be avoided.

Described in the following is, first of all, a light barrier 5 according to the prior art. Such a light barrier can be seen in FIG. 2.

The emitter 10 consists of a point-like light source 11, the light of which is formed into a light beam with parallel running rays by means of a converging lens 12 or a lens system. This light beam 13 is incident on a receiver with a lens 15 which deflects the incident light into a light-sensitive cell 16 at the focus of the lens 15.

If a pane of glass 4 is located in the light beam 13, some rays are shaded so that the intensity received by the light-sensitive cell 16 is reduced. This is used by the evaluation circuit 6 to display a switching signal.

FIG. 2 especially shows a misadjustment. This can comprise an original misadjustment but also one which has arisen as a result of the unavoidable thermal expansion during operation of the installation or as a result of pressure change when the processing chamber is evacuated. It may be seen that as a result of thermal expansion and pressure change, the pane of glass 4 is located obliquely in the light beam 13 and thereby brings about a substantially greater shading which significantly minimises the light intensity at the light-sensitive cell 16, whereby a thicker pane is simulated. In the case that the substrate is only slightly oblique, light is reflected from the side of the substrate which also leads to measuring errors.

In contrast, FIG. 3 shows a light barrier according to the invention. The emitter 10 generates a light beam 13, the height of which is significantly greater than the thickness of the panes of glass 4 to be coated. The light is not collected in the receiver 14 but rather is brought onto a series arrangement of a plurality of light-sensitive cells 16. These are arranged one above the other and approximately cover the height of the light beam 13. Generally, about twenty light-sensitive cells 16 are required for this purpose. However, the number of cells is determined by the substrate height and the accuracy of measurement to be achieved. At a height of 4 mm and an accuracy of 0.1 mm, at least 40 cells are required.

The sensitive area of each cell is hereinafter designated as a pixel. Several pixels are assigned to one detection region 18. When a pane of glass 4 passes through the light beam 13, pixels in the detection region 18 are shaded and thus no longer deliver any significant signal. The evaluation circuit 6 which is connected to all the cells 16 can determine this and can generate a corresponding switching signal when a minimum number of cells in the detection region 18 delivers such a significantly reduced signal.

The height of the pixels is now selected so that even with very thin substrates at least one or two cells 16 are completely covered so that there is a significant difference to the illumination in the case of a non-interrupted light barrier.

As shown in FIG. 4, the system is also insensitive to disadjustments. More pixels are covered than would correspond to the thickness of the substrate, however, on the other hand, light reflected from the obliquely located surface of the pane of glass 4 can lead to an increase in the light intensity in the cells adjacent to the shaded cells, which can be used for a correction to the thickness determination. In general, however, a small error in the thickness determination can be accepted since the thickness of the panes 4 only needs to be determined roughly for reliable operation of the installation.

It is thus decisive for the invention that, instead of one intensity measurement in one cell, the recorded intensity of which only changes slightly in the event of small obstacles in the ray path, a series of individual cells are used which are completely shaded in the detection region and thus always deliver a significantly reduced signal when a pane of glass passes through the ray path.

### REFERENCE LIST

1, 2 Stations
3 Roller conveyor
4 Panes of glass
5 Light barriers
6 Evaluation unit
7
8
9
10 Emitter
11 Light source
12 Lens
13 Light beam
14 Receiver
15 Lens
16 Light-sensitive cell
17
18 Detection region

1. An installation for processing plate-shaped substrates, especially for coating panes of glass, comprising a transport path on which the substrates to be processed are successively fed to a processing station, and a light barrier over the transport path in order to be able to control the flow of the substrates, wherein the light barrier comprises an emitter which emits a light beam over the transport path to a receiver connected to an electronic evaluation device, which is installed such that, as a result of the shading of the receiver by the substrates guided over the transport path, it generates a switching signal which indicates the presence of a substrate in the light beam, wherein the receiver has a plurality of light-sensitive cells arranged one above the other, wherein the evaluation circuit is set up such that the switching signal is emitted when more than a certain minimum number of cells is shaded.

2. The installation according to claim 1, wherein a part of the cells forms a detection region and that the switching signal is emitted when more than a certain minimum number of cells is shaded in the detection region.

3. The installation according to claim 2, wherein the minimum number of cells, the shading of which triggers a switching signal, is determined such that the vertical region covered thereby is smaller than the smallest substrate height to be processed by the installation.

4. The installation according to claim 1, wherein the switching signal contains the number of shaded cells.

5. The installation according to claim 2, wherein the switching signal contains the number of shaded cells.

6. The installation according to claim 3, wherein the switching signal contains the number of shaded cells.
